(19) United States
(12) Patent Application Publication
(10) Pub. No.: US 2006/0086842 A1
(43) Pub. Date: Apr. 27, 2006

(54) Grinder and spreader apparatus and method

(76) Inventors: Gary Cervelli, Coram, NY (US); Walter Titcomb, Ronkonkoma, NY (US)

Correspondence Address: CARTER, DELUCA, FARRELL & SCHMIDT, LLP, 445 BROAD HOLLOW ROAD, SUITE 225, MELVILLE, NY, 11747, US

(21) Appl. No.: 11/210,648

(22) Filed: Aug. 24, 2005

Related U.S. Application Data
(60) Provisional application No. 60/638,570, filed on Dec. 23, 2004.
(60) Provisional application No. 60/604,077, filed on Aug. 24, 2004.

(51) Int. Cl. B02C 25/00

(52) U.S. Cl. 241/30

(57) ABSTRACT

A method and apparatus is disclosed for distributing material onto a surface. The method includes the steps of grinding the material and spreading the material onto a surface. The truck grinder and spreader apparatus has a grinding mechanism for grinding material after it is discharged from a conveyor within a truck body and has a spreading mechanism for distributing the material that has passed through the grinding mechanism onto a surface. The grinding mechanism reduces the size of discharged materials to a predetermined maximum size, and thus prevents the spreading of undesirably large pieces of material. The truck body may include a tailgate that is movable between an open position and a closed position such that when the tailgate is in the open position, material can be discharged from the truck body. The truck may also include a screen positioned atop the truck body for screening the material that is loaded into the truck body.

### BACKGROUND

1. Technical Field

The present disclosure generally relates to a method and apparatus for grinding and spreading material from trucks onto a surface. The disclosure has notable utility in trucks of the type having a truck body with a conveyor for conveying the material contents of the truck body rearwardly and into a grinding mechanism prior to discharging the contents at the rear end of the truck body.

2. Background of Related Art

Trucks equipped with spreading mechanisms for distributing materials onto a paved surface are generally known. Certain materials to be spread on pavement, however, clump or agglomerate when stored, especially in the presence of moisture. One such material is sodium acetate, a material frequently spread on airport runways to reduce icing. Discharge of large chunks of material is undesirable. Also, large agglomerations of material can block or clog up the spreading mechanism within the truck.

It would be advantageous to provide a method for efficiently and effectively spreading material of the type that have a tendency to clump or agglomerate and a truck that includes a spreading mechanism for such materials that overcomes these problems.

### SUMMARY

A method for distributing material onto a surface, including the steps of grinding the material and spreading the material is provided. A truck grinder and spreader apparatus having a grinding mechanism for grinding material after it is discharged from a conveyor within a truck body and having a spreading mechanism for distributing the material that has passed through the grinding mechanism onto a surface is also provided. The grinding mechanism reduces the size of discharged materials to a predetermined maximum size. The introduction of the grinding mechanism prevents the spreading of undesirably large pieces of material. The grinding mechanism and the spreading mechanism are discussed in detail below.

The truck body can include a rear tailgate. When the rear tailgate is closed, the material is maintained within the truck body. The opening of the rear tailgate allows the material to be dispensed out the rear of the truck body and onto the grinding mechanism. In one version the rear tailgate is only capable of being moved to the open position when the grinding mechanism and the spreading mechanism are activated.

The truck body may also include a first chute for directing material that is discharged from the truck body onto the grinding mechanism.

The grinding mechanism includes a drive system operatively connected to a grinder configured to receive material to be ground. In one version the grinding mechanism includes a motor, a chain, and proximal and distal shafts with grinding teeth. The motor engages the chain and the movement of the chain causes the shafts and teeth to rotate. The rotation of the shafts and teeth causes material in the grinding mechanism to be ground.

The truck body may include a second chute for directing the material from the grinding mechanism to the spreading mechanism.

The spreading mechanism includes structure for dropping or broadcasting material onto a desired surface. In one version the spreading mechanism includes a motor, a drive shaft and a spinner. The motor engages the drive shaft and causes it to rotate. The drive shaft extends vertically from the center of the spinner and causes the spinner to rotate. The rotation of the spinner causes the material that is dropped onto the spreading mechanism to be distributed onto the desired surface.

In one embodiment, the truck body includes a screen positioned atop the truck body for screening large material as it is loaded into the truck body. In one embodiment, the screen is positioned along the top of the truck body and is in two halves. Each half of the screen is movably connected to the truck body and is not restricted from upward movement. Each half of the screen engages with a lift mechanism, such as a hydraulic piston, for opening the screen. A center bar can be provided traversing the opening of the truck bed for supporting the screen and for anchoring the lift mechanisms. The screen itself can also be strengthened with supports. When the screen is lifted, the large material exceeding a predetermined size can be dumped off the sides of the truck body.

In another embodiment, the screen has an outwardly curved shape for allowing the material that is too large to pass through the screen to fall to the sides of the truck body without having to elevate or pivot the screen. In this embodiment, the screen may also be strengthened with reinforcing arcuate ribs, a horizontal support and vertical supports to allow the screen to withstand a heavy load of material that is dumped thereon.

The method of the present disclosure includes providing a truck body with a rear tailgate, a conveyor, a grinding mechanism and a spreading mechanism. To operate the grinder and spreader apparatus, the rear tailgate is opened to allow the unground material to be moved by the conveyor to the grinding mechanism. The grinding mechanism then grinds the material that exceeds the predetermined maximum allowable size. From the grinding mechanism, the material that is smaller than or equal to the predetermined maximum size is moved to the spreading mechanism. The spreading mechanism distributes the material from the grinding mechanism onto a surface.

### BRIEF DESCRIPTION OF THE DRAWINGS

Embodiments of the presently disclosed grinder and spreader apparatus are described herein with reference to the drawings, wherein:

FIG. 1 is an enlarged, partial side elevation view of a truck having a grinding mechanism located above a spreading mechanism in accordance with this disclosure;

FIG. 2 is an enlarged side view of the rear end of the truck of FIG. 1 showing the grinding mechanism and the spreading mechanism;

FIG. 3 is a rear end view of the truck of FIGS. 1-2 showing a rear tailgate in a closed position;

FIG. 4 is a rear end view of the truck of FIGS. 1-3 showing the rear tailgate in an open position;

FIG. 5 is a partial side elevation view of the truck of FIGS. 1-4 showing the grinding mechanism located above the spreading mechanism, showing the rear tailgate in a closed position and showing an optional screen in an open position located atop the truck body;

FIG. 6 is a partial perspective view showing the front of the truck of FIGS. 1-4 with an optional curved screen in place;

FIG. 7 is a partial perspective view showing the front of the truck of FIGS. 1-5 with an optional flat screen in place, illustrated in a closed position;

FIG. 8 illustrates the optional flat screen of FIG. 7 in an open position;

FIG. 9 is a perspective view of the grinding mechanism illustrated with longitudinally off-set teeth;

FIG. 10 is a perspective view of the grinding mechanism of FIG. 9 illustrated with longitudinally in-line teeth;

FIG. 11 is a top view of the grinding mechanism of FIG. 10; and

FIG. 12 is a top plan view of a spinner of the spreading mechanism.

### DETAILED DESCRIPTION OF PREFERRED EMBODIMENTS

Referring now in specific detail to the drawings in which like referenced numerals identify similar or identical elements throughout the several views. In the drawings and in the description which follows, the term “proximal” will refer to the portion of the grinder and spreader apparatus which is closest to the front of the truck, while the term “distal” will refer to the portion of the grinder and spreader apparatus which is farthest from the front of the truck.

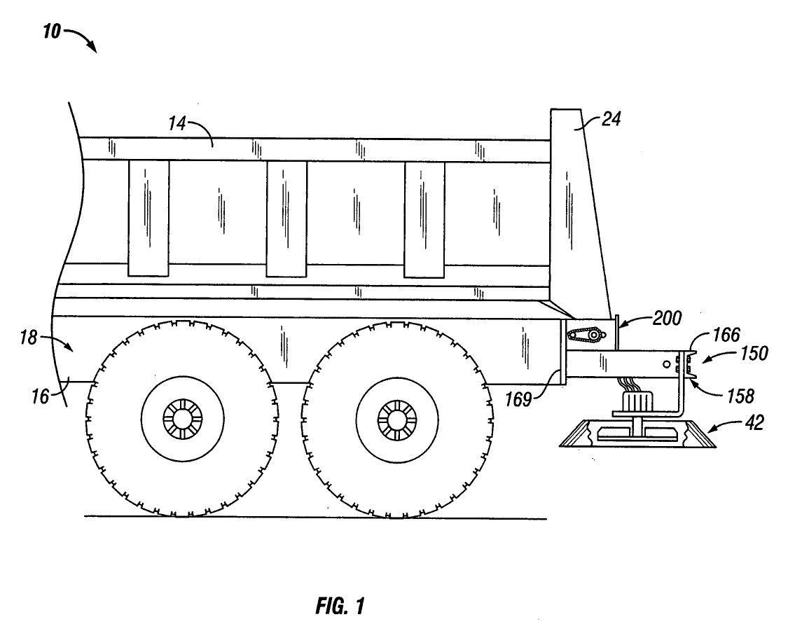

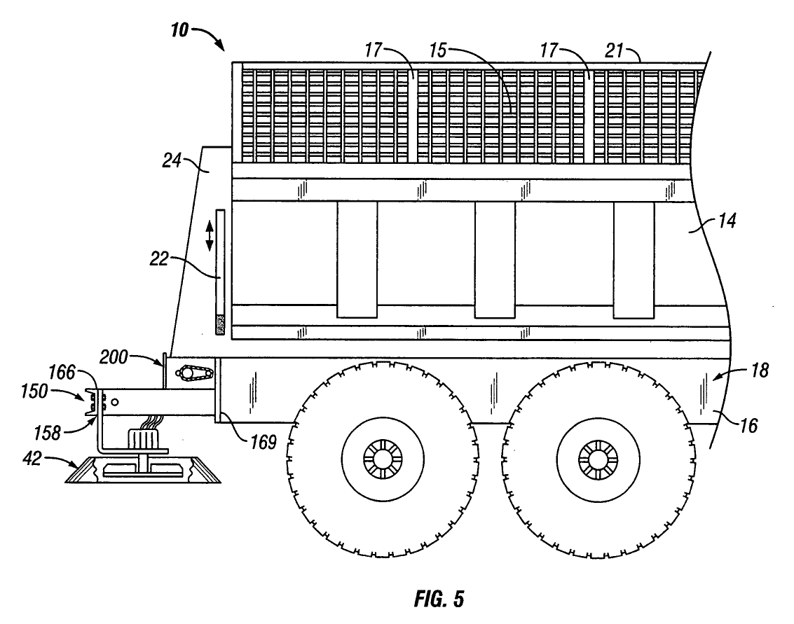

A truck 10 includes a truck body 14 mounted on a truck frame 18. The truck 10 incorporates a grinding mechanism 200 positioned above a spreading mechanism 150 in accordance with one embodiment of the present disclosure is shown in FIGS. 1-5.

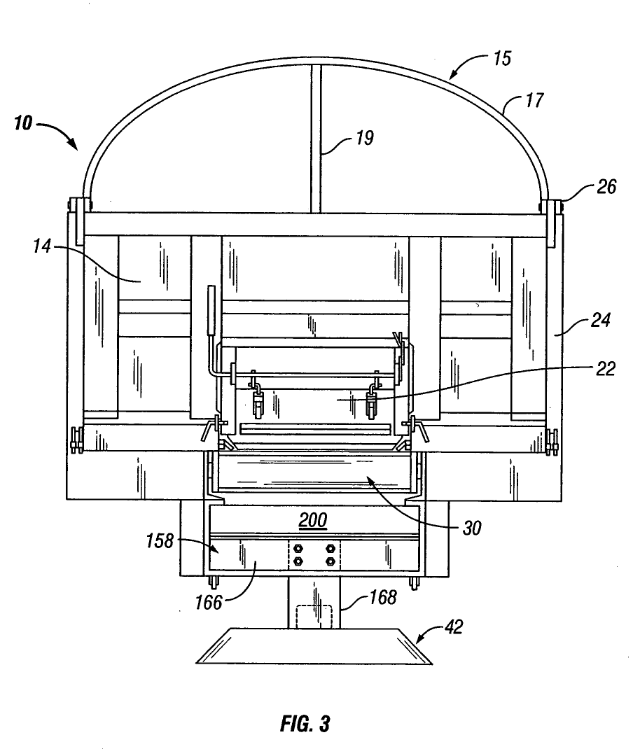

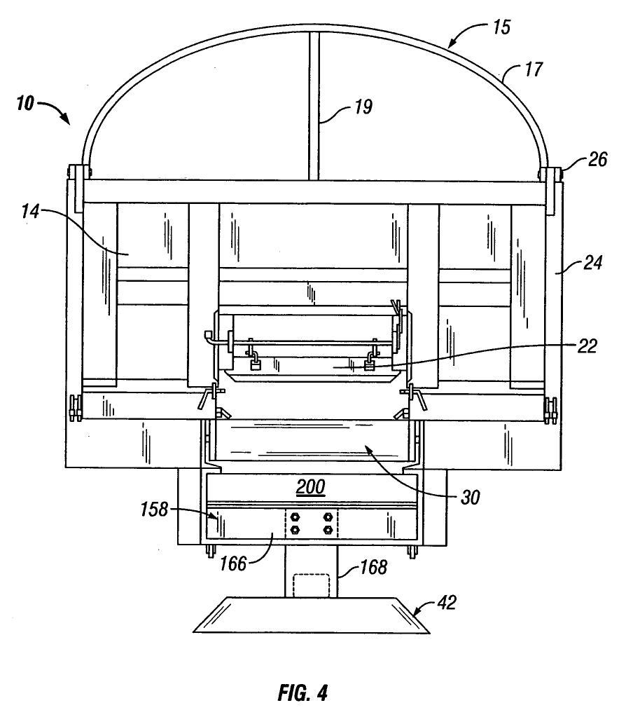

The truck body 14 has a rear tailgate 22 which, in its closed position (FIG. 3), prevents the material in the truck body 14 from unintentionally exiting the truck body 14. In its open position (FIG. 4), the rear tailgate 22 allows for the material in the truck body 14 to be discharged to the grinding mechanism 200, as described below. In this embodiment, the act of opening the rear tailgate 22 is coordinated with the operation of the grinding mechanism 200 and the spreading mechanism 150. In such an embodiment, material cannot be discharged from the truck body 14 unless the grinding mechanism 200 and the spreading mechanism 150 are activated, thereby preventing material from not being ground and from being unintentionally dropped onto a surface.

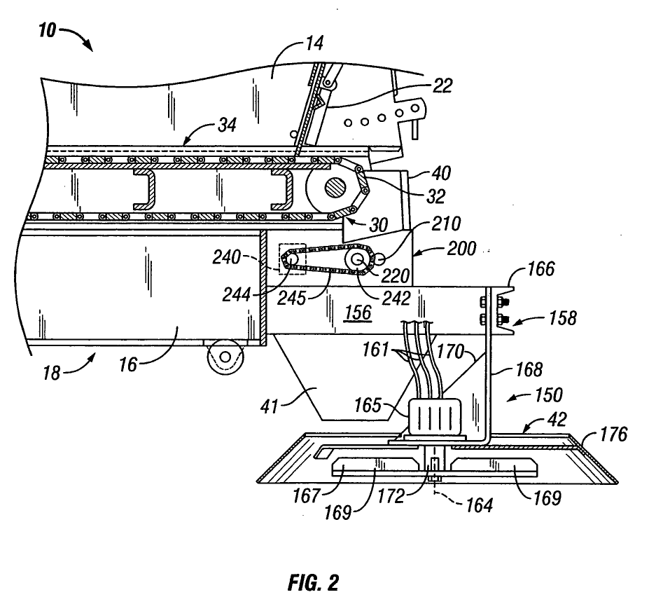

A conveyor system 30 is integrated into a bottom structure 34 of the truck body 14 to provide a multiple purpose truck which can be used in a conveyor dispensing mode of operation. The conveyor system 30 is best seen in FIG. 2. Integrated conveyor systems are generally known to those skilled in the art and the embodiment shown includes a central, longitudinally extending conveyor 32 in the bottom structure 34 of the truck body 14.

A first chute 40 is mounted in part on the truck frame 18 below the rear end of the conveyor 32 and directs the material contents of the truck body 14 to grinding mechanism 200.

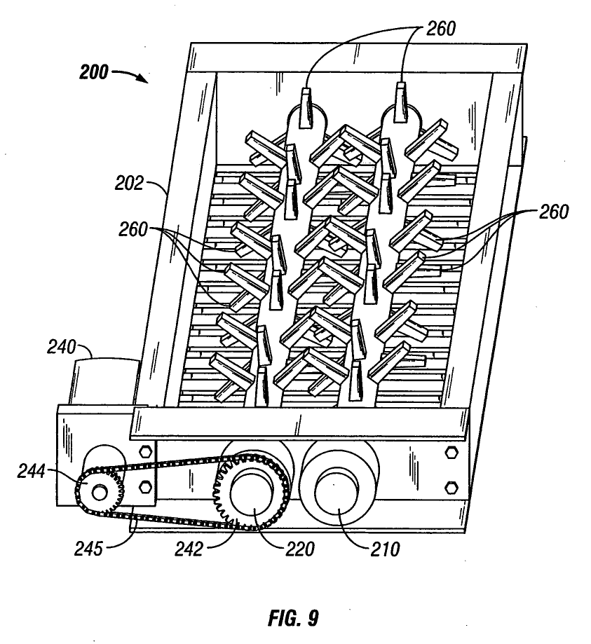

The grinding mechanism 200 is shown in FIGS. 9-11. When the material contained in the truck body 14 is directed onto the grinding mechanism 200 by conveyor 32, portions of such material may pass through grinding mechanism 200 if they are of a small enough size. Clumps of material that are too big to simply pass through grinding mechanism 200 are ground until they are small enough to pass though the grinding mechanism 200. Grinding mechanism 200 generally comprises housing 202, distal shaft 210, proximal shaft 220, motor 240, proximal gear 242, motor gear 244, chain 245, distal shaft teeth 250, proximal shaft teeth 252 and grinding teeth 260. Motor 240, which can be powered by any means (e.g., electrical, pneumatic, hydraulic, etc.), causes motor gear 244 to rotate. Chain 245 rests on and between teeth of gears 242 and 244. Motor gear 244 causes chain 245 to move and thus to rotate proximal gear 242. Proximal gear 242 is operatively connected to proximal shaft 220. Rotation of proximal gear 242 causes proximal shaft 220 to rotate. Proximal shaft teeth 252 are operatively connected to proximal shaft 220 and rotate as proximal shaft 220 rotates. Distal shaft teeth 250 are in contact with proximal shaft teeth 252 and consequently rotate in the opposite direction. Distal shaft 210 is operatively connected to distal shaft teeth 250 and thus distal shaft 210 rotates in the same direction and at a proportionate speed as distal shaft teeth 250. Both shafts 210 and 220 rotate in opposite directions and the grinding teeth 260 that are operatively attached to each shaft 210 and 220 consequently rotate at the same rate and direction as their respective shafts.

The speed at which shafts 210 and 220 rotate can advantageously be in the range of about 50 to about 150 rpm, preferably about 75 to about 100 rpm, although any speed that provides acceptable grinding can be used. In this embodiment, the speed at which the conveyor 32 moves is independent of the speed at which the shafts 210 and 220 rotate, and is independent of the speed at which a spinner 167 rotates.

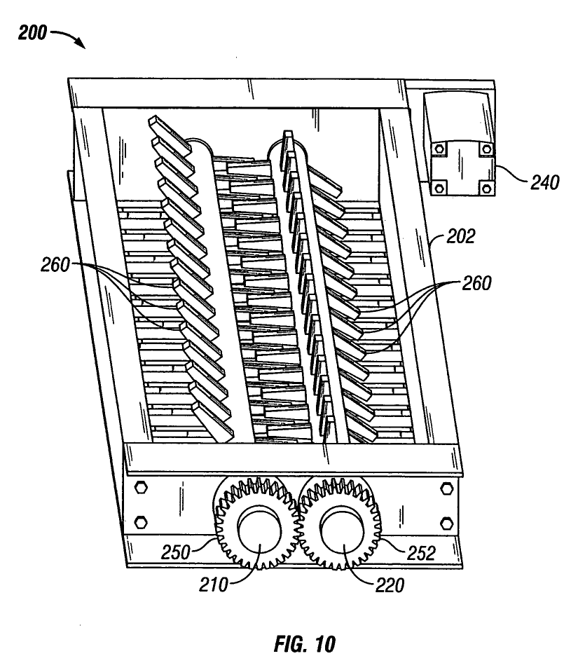

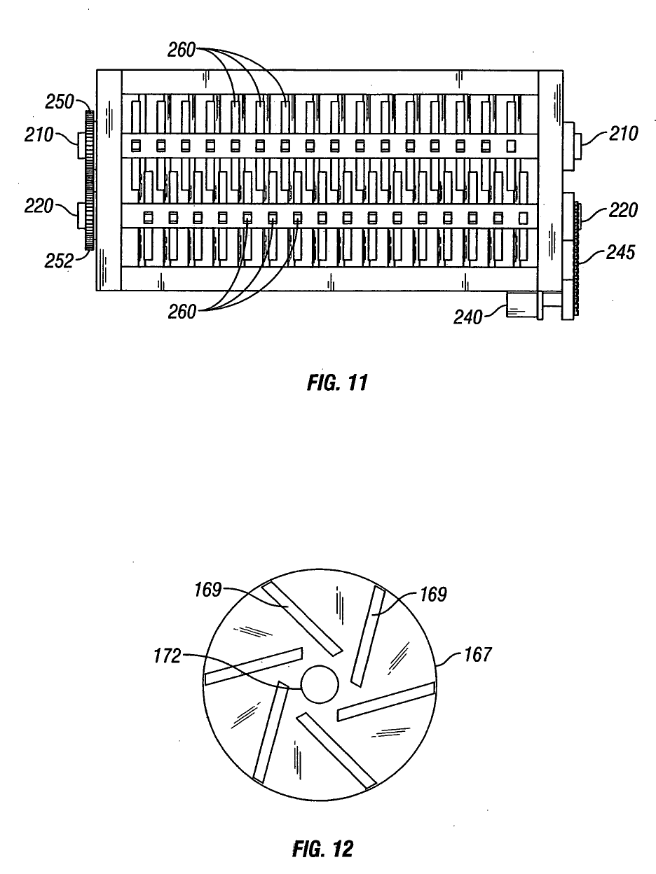

The rotation of the grinding teeth 260 causes any large chunks of material conveyed to the grinding mechanism 200 to be ground until they are small enough to pass therethrough. The size and spacing of the grinding teeth 260 and their distance from the housing 202 determines the maximum size of the material that can pass through the grinding mechanism 200. These sizes and distances can be altered depending on the type and characteristics of the material to be spread. In one embodiment, the grinding teeth 260 on both the proximal shaft 220 and the distal shaft 210 are positioned longitudinally in-line relative to their respective shafts (see FIGS. 10 and 11). In another embodiment, the grinding teeth 260 of the proximal shaft 220 and/or the distal shaft 210 are positioned in a staggered, off-set fashion, i.e., not in-line, relative to their respective shafts (see FIG. 9). In both the in-line and off-set embodiments, the grinding teeth 260 from the proximal shaft 220 and the grinding teeth 260 from the distal shaft 210 are longitudinally positioned such that they alternately engage or mesh with one another upon rotation of the shafts 210 and 220. Typically, the material should be ground to a size less than one inch.

A second chute 41, mounted below the grinding mechanism 200, directs the material that has passed through the grinding mechanism 200 to the spreading mechanism 150 (see FIG. 2).

The spreading mechanism 150 of the present disclosure can be stationary or of any other type. As seen in FIG. 2, a spreader 42 forms part of spreading mechanism 150 and mounts on the parallel channel beams 16 of the truck frame 18. Rear end structure 158 comprises a transverse channel beam 166 and one or two intermediate, laterally spaced mounting brackets 168 attached to and extending down from beam 166. The spreader 42 thereby depends via the bracket 168, from two support legs 156. The rear end structure 158 can be permanently welded to the rear ends of the two support legs 156 or optionally connected by pins or the like so as to be interchangeable with other structures (not shown). Optionally, another rear channel beam can be mounted rearwardly of cross beam 166 to serve as a rear truck bumper (not shown).

The spreader 42 is mounted below support legs 156, centrally therebetween and with the spinner 167 rotatable about an axis 164 normal to the generally horizontal plane of the beams 16 and support legs 156. A hydraulic drive motor 165 is mounted on a transverse spinner support bracket 170 with its drive shaft 172 extending upwardly through an opening in the spinner support bracket 170. The spinner 167 is mounted on and secured to the drive shaft 172 for rotation by the motor 165. The hydraulic motor 165 and hydraulic lines 161 leading to and from the motor 165 are part of a hydraulic system (having a manually operated valve and hydraulic pump, not shown) used for selectively rotating the spinner 167 with the motor 165. In one embodiment, the hydraulic lines 161 are mounted within the channel openings in the support legs 156 to protect the hydraulic lines 161 and keep them free and clear of the truck body 14.

The spinner 167 is positioned centrally between the sides 24 of the truck body 14 below the first and second chutes 40 and 41 and the rear end of the conveyor 32. In FIG. 3, the chutes have been omitted for clarity. The spreader 42 is thereby positioned for receiving the material contents of the truck body 14 discharged off the conveyor 32 at the rear end of the truck body 14 and passing downwardly through the first chute 40, through the grinding mechanism 200 and through the second chute 41. When the conveyor system 30 is operated to discharge the material contents of the truck body 14 off the rear end of the conveyor 32, the spinner 167 is rotated by its drive motor 165 to spread the discharged material onto the roadway. The spinner 167 includes a plurality of rudders 169 radially disposed from the drive shaft 172 (illustrated in FIG. 12) for helping to distribute the material onto the roadway.

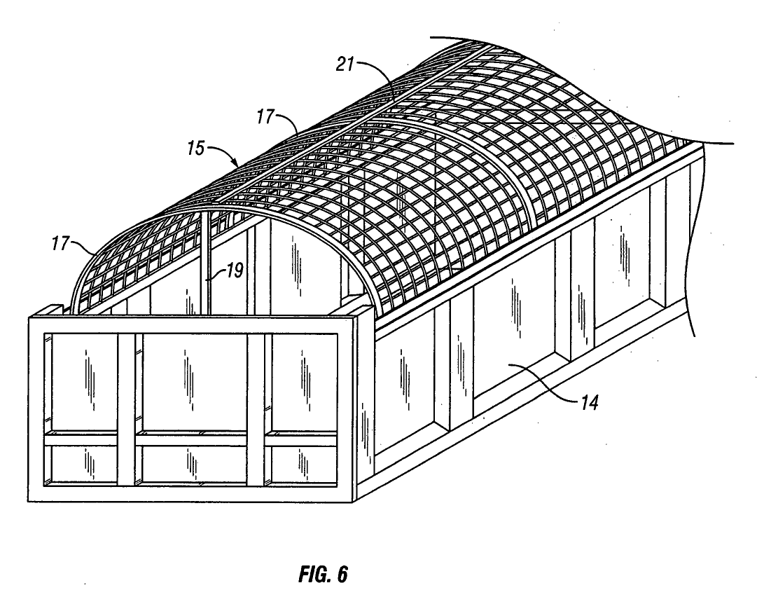

Optionally, a screen 15 is placed above truck body 14 so that when material is loaded into the truck body 14 (e.g., using a bucket loader), pieces of material that are too large to pass through the screen will be caught by the screen 15. Embodiments of the screen 15 are illustrated in FIGS. 3-8.

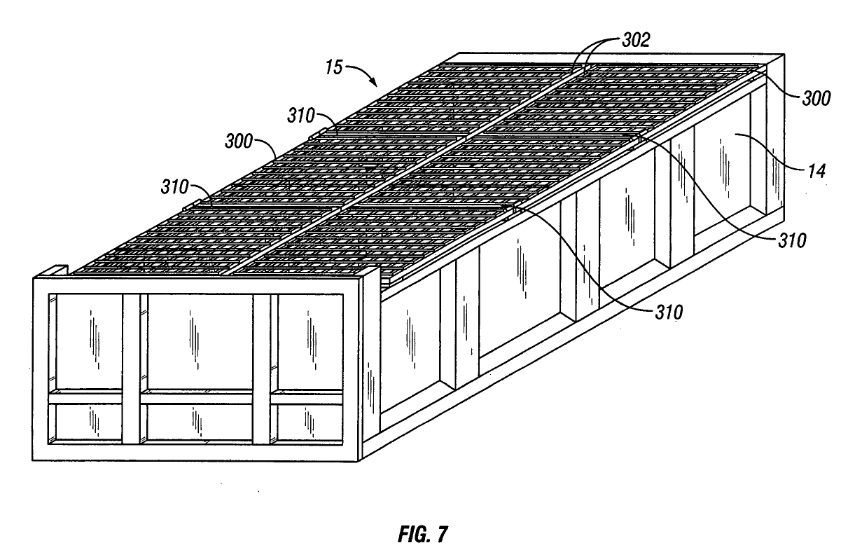

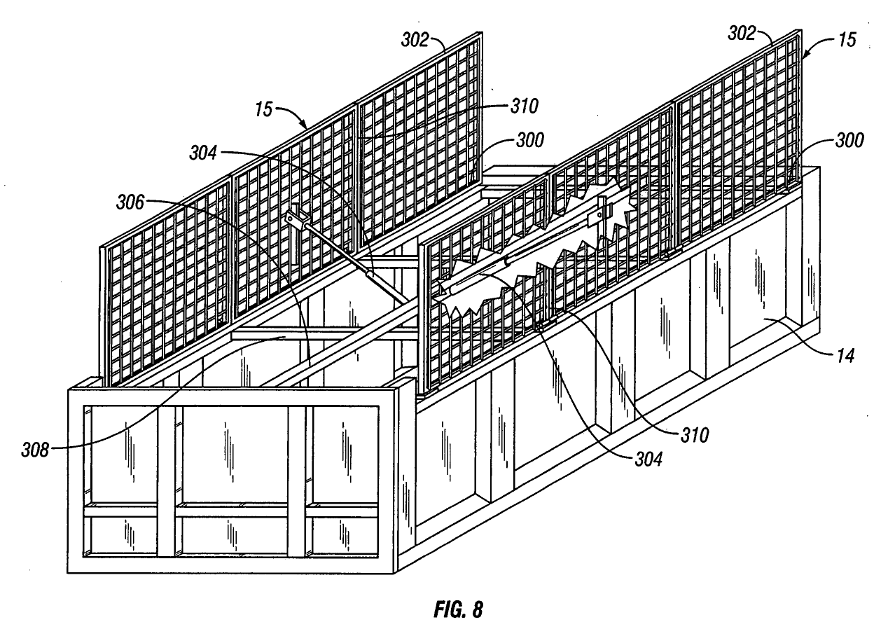

In one embodiment, depicted in FIGS. 7 and 8, the screen 15 is divided into two parts. Each part is movably connected to the side of truck body 14 at one end 300 and is not restricted from upward movement at its other end 302. A lift mechanism 304, such as a hydraulic piston, is used to lift each half of screen 15. One end of the lift mechanism 304 is operatively connected to the screen 15. The other end of the lift mechanism 304 is operatively connected to a center bar 306 that traverses the length of the truck body 14 and also functions to support the screen 15 when in a closed position (FIG. 7). In one embodiment, cross beams 308 are disposed on the top of the truck body 14, traversing the width thereof, for providing additional support for the screen 15. Screen supports 310 are disposed on the screen 15, in one embodiment, for providing yet additional support.

When the truck 10 is loaded with material, the material that is too large to pass through the screen 15 remains thereon. The lifting of the screens 15 causes the large material to fall off the sides of truck body 14. It is also contemplated that the lift mechanisms 304 lift the screens 15 in a non-steady, or shaky motion, for sifting the material through the screens 15 as they open.

In another embodiment, the screen 15 is curved so that when material is loaded onto the truck 10, the large pieces of material roll off the sides of the truck 10. In one embodiment, the screen 15 has reinforcing arcuate ribs 17, vertical supports 19 and horizontal support 21 to provide adequate strength to withstand the removal of any large pieces that remain on screen 15 without damaging the screen 15.

Although the illustrative embodiments of the present disclosure have been described herein with reference to the accompanying drawings, it is to be understood that the disclosure is not limited to those precise embodiments, and that various other changes and modifications may be affected therein by one skilled in the art without departing from the scope or spirit of the disclosure. For example, the truck body can be either a stationary or a moveable truck body. As another example, the conveyor can be a belt-type conveyor or a screw-type conveyor. As another example, the screen can be one piece and lifted by a single lift mechanism. As another example, a side of the screen can have a curved shape for further ensuring large pieces of material do not enter the truck body. As another example, the spreader can be stationary or moveable (e.g., retractable or pivotable). As another example, the motor for driving the spinner can be powered by means other than hydraulic, such as electrical, pneumatic, etc. As yet another example, the grinding mechanism can contain any reasonable number of shafts, including a single shaft. All such changes and modifications are intended to be included within the scope of the appended claims.

What is claimed is:

1. A truck body for containing and discharging material, comprising:
a grinding mechanism operatively mounted with the truck body and configured to grind material to a predetermined size; and
a spreading mechanism mounted to receive and discharge the material from the grinding mechanism.

2. The truck body of claim 1 further comprising a conveyor for moving material to the grinding mechanism.

3. The truck body of claim 1 further comprising a tailgate movable between an open position and a closed position such that when the tailgate is in the open position, material can be discharged from the truck body.

4. The truck body of claim 3 wherein the tailgate is moved from the closed position to the open position when the grinding mechanism is activated.

5. The truck body of claim 1 further comprising a screen positioned above the truck body for screening the material to be loaded into the truck body.

6. The truck body of claim 5, wherein the screen is curved for allowing material which exceeds a predetermined size to roll off the truck body.

7. The truck body of claim 5 further including screen supports to enhance the weight bearing capacity of the screen.

8. The truck body of claim 5, further including a lifting mechanism to raise the screen relative to the truck body.

9. The truck body of claim 8, wherein the lifting mechanism raises the screen at a non-constant rate.

10. The truck body of claim 8, wherein the lifting mechanism includes a hydraulic piston.

11. The truck body of claim 1 further including a chute for directing the unground material discharged from the truck body to the grinding mechanism.

12. The truck body of claim 1 further including a chute for directing the material discharged from the grinding mechanism to the spreading mechanism.

13. The truck body of claim 1, wherein the grinding mechanism includes a housing, a proximal shaft having a first end and a second end, the proximal shaft defining a proximal axis, a distal shaft having a first end and a second end, the distal shaft defining a distal axis, the proximal shaft and the distal shaft being operatively engaged with the housing, a plurality of grinding teeth disposed on each of the shafts, and a motor for rotating the proximal shaft about the proximal axis.

14. The truck body of claim 13 wherein the rotation of the proximal shaft causes the distal shaft to rotate about the distal axis.

15. The truck body of claim 13 wherein the grinding teeth are disposed on at least one shaft in an in-line position.

16. The truck body of claim 13 wherein the grinding teeth are disposed on at least one shaft in an off-set position.

17. The truck body of claim 13 further including proximal gears disposed on the second end of the proximal shaft and distal gears disposed on the second end of the distal shaft, such that proximal gears mechanically engage with distal gears, whereby rotation of the proximal shaft causes the proximal gears, the distal gears and the distal shaft to rotate.

18. The truck body of claim 13 wherein the maximum space between each of the grinding teeth, and between the grinding teeth and the housing is pre-determined to equal the maximum size of material that is desired to pass through the grinding mechanism.

19. The truck body of claim 1 wherein the spreading mechanism includes a spinner and a motor having a drive shaft for rotating the spinner, the drive shaft defining an axis.

20. The truck body of claim 19 wherein the motor is a hydraulic motor.

21. The truck body of claim 1 further including a beam and a bracket for supporting the spreading mechanism below the grinding mechanism.

22. The truck body of claim 1 wherein the predetermined size of the material to be ground is less than one inch.

23. The truck body of claim 14 wherein the proximal and distal shafts rotate in the range of about 50 to about 150 rpm.

24. The truck body of claim 14 wherein the proximal and distal shafts rotate in the range of about 75 to about 100 rpm.

25. A truck, comprising:
a truck body for containing and discharging material;
a grinding mechanism operatively mounted with the truck body and configured to grind material to a predetermined size; and
a spreading mechanism mounted to receive and discharge material from the grinding mechanism.

26. A method for spreading material on a surface including the steps of:
providing a truck body, the truck body having a conveyor for moving material to a grinding mechanism and then to a spreading mechanism for receiving and discharging material from the grinding mechanism, and the truck body having a tailgate;
opening the tailgate to allow unground material to move to the grinding mechanism;
operating the grinding mechanism, whereby material greater than a predetermined size is ground into smaller pieces and is moved to the spreading mechanism; and
operating the spreading mechanism, whereby the material deposited from the grinding mechanism is distributed onto a surface.

27. The method of claim 26 wherein the material to be spread is sodium acetate.

28. The method of claim 26 further including the step of screening the material with a screen positioned above the truck body prior to the step of opening the tailgate.
